(19) United States
(12) Patent Application Publication
(10) Pub. No.: US 2012/0056417 A1
(43) Pub. Date: Mar. 8, 2012

(54) Modified Pipe Tee, an Associated Combination Fitting and Method of Use Thereof

(76) Inventor: Eric Gray, Pahrump, NV (US)

(21) Appl. No.: 12/875,661

(22) Filed: Sep. 3, 2010

(51) Int. Cl. F16L 39/00; B23P 17/04

(52) U.S. Cl. 285/133.11; 29/428

(57) ABSTRACT

A pipe tee that has been modified to permit a second standard pipe tee to fit within it is described. The resultant 4-way combination fitting permits the angle of the respective annular appendages of the tees to be adjusted relative to each other.

### FIELD OF THE INVENTION

The present invention pertains generally to tubular pipe and associated fittings for use in constructing the framework for three dimensional structures.

### BACKGROUND

Polyvinylchloride pipe more commonly referred to PVC pipe is a common plastic pipe used in household and commercial buildings as plumping conduit whether for distributing water throughout a building under pressure or for the removal of drain water and other wastewater from a building. Other types of pipe made of polymeric material are beginning to become popular as well. On the whole, PVC pipe and other plastic pipe is lightweight and relatively inexpensive making it both easy and convenient to use not only for contractors but do-it-yourself homeowners as well. As a consequence of its ease of use and cost, plastic pipe has become readily available in so-called big box stores, such as Home Depot®.

Over the years people have realized that PVC and other plastic piping could be used in light structural framing applications that were unrelated to fluid flow. PVC pipe proved to be rigid enough and inexpensive enough to facilitate the construction of temporary shelters, car ports, dog houses, canopies and the like. Typically, the PVC pipe along with suitable fittings is used to construct a framework over which fabric or other lightweight materials are laid and attached.

Constructing a PVC pipe framed structure is usually relatively simple. PVC piping is cut to the appropriate lengths and then the ends of the tubes are fusion bonded into appropriate fittings that attach the tubes to each other in a variety of angular relationships. After the PVC pipe framework has been completed, a builder typically lays fabric or lightweight sheet material over at least portions of the structure, such as the roof and secures the fabric to the structure to complete the enclosure.

The design and configuration of any PVC pipe structure is ultimately limited be the fittings that are available to join the sections of pipe. While there are many types of fittings available to join tubes together orthogonally and several standard intermediate angles of intersection, such as 45 degrees, there are very few choices available for joining tubing together at non-standard angles of intersection. This can present problems, for instance, when designing and building PVC framed structures with gabled roofs having non-standard slopes.

For example to create a roof pitch of 40 degrees, at least four fittings are required to assemble a left and right pair of rafter pipes and the rafter pipes of the resulting rafter pair are not planar with each other. For example, two 90 degree standard tees can be placed one next to each other along a ridge pipe (or series of connected ridge pipe sections by angling the 90 degree appendages downwardly at an angle of 40 degrees off of horizontal with one facing to the left of the ridge pole and one facing to the right. The rafter pipes are secured in the respective left and right facing appendages at their top ends and in tee fittings that are secured to horizontal top pipes on the associated walls on the other ends. Not only are the corresponding rafter pipes not in planer relative to each other, they typically cannot be in a planer relationship with a vertical wall support pipe (or stud pipe) of the PVC pipe structure. Most significantly such an arrangement is not efficient in terms of resisting loads encountered by the structure during normal use. For instance, load experienced by the roof, such as wind or snow loads are transferred from one of the left and right rafter pipes across the ridge pipe and to its companion rafter pipe; whereas, if companion rafter pipes where inline or planar, the loads could be more transferred directly between them avoiding unnecessary loading on the ridge pipe. Similarly, because the rafter pipes are not in a planar relationship with the stud pipes, downwardly vectored load must be transferred through the respective walls' horizontal top pipes before being transferred to the stud pipes pipes. These loading inefficiencies require a PVC pipe structure to be built more stoutly (and hence more expensively) for a given load then if a more direct load transfer path were possible.

### BRIEF DESCRIPTION OF THE DRAWINGS

FIG. 1 is an isometric view of a standard pipe tee as known in the art but additionally utilized in embodiments of the present invention.

FIG. 2 is an isometric view of a modified pipe tee accordingly to an embodiment of the present invention.

FIG. 3 is an isometric view of an assembly comprising a standard pipe and a modified pipe tee according to an embodiment of the present invention.

FIG. 4 is an end view of the modified pipe tee illustrated in FIG. 2 according to an embodiment of the present invention.

FIG. 5 is a side view of the modified pipe tee illustrated in FIG. 2 according to an embodiment of the present invention.

FIG. 6 is a top view of the modified pipe tee illustrated in FIG. 2 according to an embodiment of the present invention.

FIGS. 7A & 7B are partial isometric views of a pipe structure assembly utilizing the pipe tee assembly of FIG. 3 according to an embodiment of the present invention.

### DETAILED DESCRIPTION

Embodiments of the present invention comprise (i) a modified pipe tee, (ii) a combination fitting combining the modified pipe tee with a standard pipe tee, (iii) structures fabricated using the combination fitting and (iv) a method of using the assembly to construct the structures.

The modified pipe tee is a variation on a standard pipe tee. Specifically, the inclusion of two cut out sections in the tee results in a modified tee that when utilized in combination with a standard pipe tee creates a fitting that ameliorates one or more of the problems recited in the background section. The modified pipe tee can be fabricated by modifying a standard pipe tee but additionally and perhaps more suitably for mass production, the modified pipe tee can be molded in its novel configuration reducing or eliminating the need for secondary manufacturing operations.

Of significance, the combination of the modified pipe tee and a appropriately sized standard pipe tee (hereafter referred to as a “combination fitting” or “combination tee”) with a standard tee received within the modified tee, such that they can rotate along a longitudinal axis relative to each other, permits the construction of plastic pipe roofs with a wide variety of slopes wherein corresponding left and right rafter pipes are planarly aligned. Further, the rafter pipe on their eave ends can be aligned with vertical wall support pipes (also “stud pipes”) of the associated structure for efficient load transfer from the roof to the walls. More specifically, the combination creates a 4-way pipe fitting that permits the angle between the two appendages that extend respectively from the modified tee and the standard tee to be varied relative to each other.

Advantageously, the use of the combination tee reduces the time required to construct a plastic pipe structure as a single fitting can be used in place of two or even four prior art fittings thereby reducing the time required to erect the structure. However, perhaps more significantly, the use of the combination tee with the adjustable angle feature permits a structure to be build ad hoc without as much concern about (i) whether the pitch or slope of the roof will be correct if using fixed angle fittings, or (ii) all the extra pipe cuts and joints required to account for the out of plane rafter pipe pairs.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, tense or any singular or plural variations of the defined word or phrase.

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “a variation”, “one variation “, and similar phrases mean that a particular feature, structure, or characteristic described in connection with the embodiment is included in at least an embodiment of the invention. The appearances of phrases like “in one embodiment”, “in an embodiment”, or “in a variation” in various places in the specification are not necessarily all meant to refer to the same embodiment or variation.

The term “integrate” or “integrated” as used in this specification and the appended claims refers to a blending, uniting, or incorporation of the identified elements, components or objects into a unified whole.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

As applicable, the terms “about” or “generally” as used herein unless otherwise indicated means a margin of +−20%. Also, as applicable, the term “substantially” as used herein unless otherwise indicated means a margin of +−10%. It is to be appreciated that not all uses of the above terms are quantifiable such that the referenced ranges can be applied and as such where the indicated margins are not readily applicable, the foregoing terms have meanings attributable to them as would be understood by someone of ordinary skill in the art given the benefit of this disclosure.

The terms “pipe tee” and “tee” are used interchangeably herein and refer to a fitting for joining pipe together typically by receiving the end of a pipe in to a cavity or socket formed in the fitting. A “tee” is a three way fitting that is used to join three pipes together with two of the pipes being longitudinally aligned and the third pipe extending orthogonally relative to the other two.

The term “cutout” is used herein to describe features of the modified pipe tee. While the term implies a region or area that has been physically removed from an associated article, this is not necessarily the case. Rather the term is used herein to indicate an area or region where there is no material and is not meant to imply that the material was physically removed from the tee during manufacture or fabrication. Using one method of making the modified pipe tee, the cutouts can be formed in place at the same time that the remainder of the modified tee is molded from plastic or any other suitable material.

The abbreviation “PVC” stands for Polyvinylchloride polymeric material. PVC is well known for use in PVC pipes. The phrase “plastic pipe” as used herein refers to any pipe made of any suitable polymeric material including but not limited to PVC.

The term “circumferential width” is used to designate a distance along a circumference between two points or, as in the case of this application, between two edges. For instance, the circumferential width of the first cutout of the modified pipe tee as is described in detail below is the distance measured from one edge to the other along an imaginary arc having a diameter the same as the diameter of the modified tee's base portion. In other words, the circumferential width is the distance measured along what would be the circumference of the base portion had the base portion sidewall continued unimpeded at the location of the cutout. In contrast, the “linear width” measures a straight line distance between two points or edges. Concerning the first cutout the linear distance between the opposing edges is the linear width. As can be ascertained from the two definitions, the linear width for a section removed from a cylinder, such as the first cutout will always be less than the circumferential width of the same cutout.

### A Modified Pipe Tee According to An Embodiment of the Present Invention

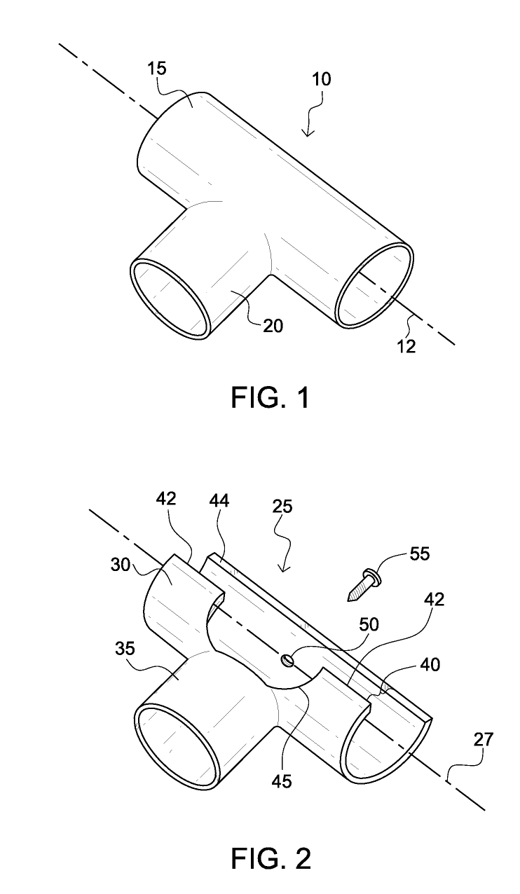

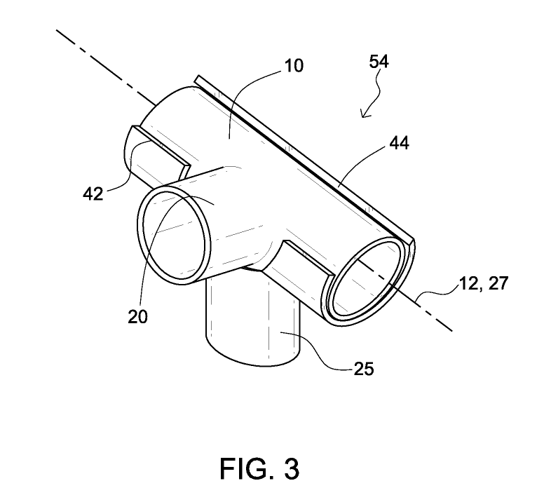

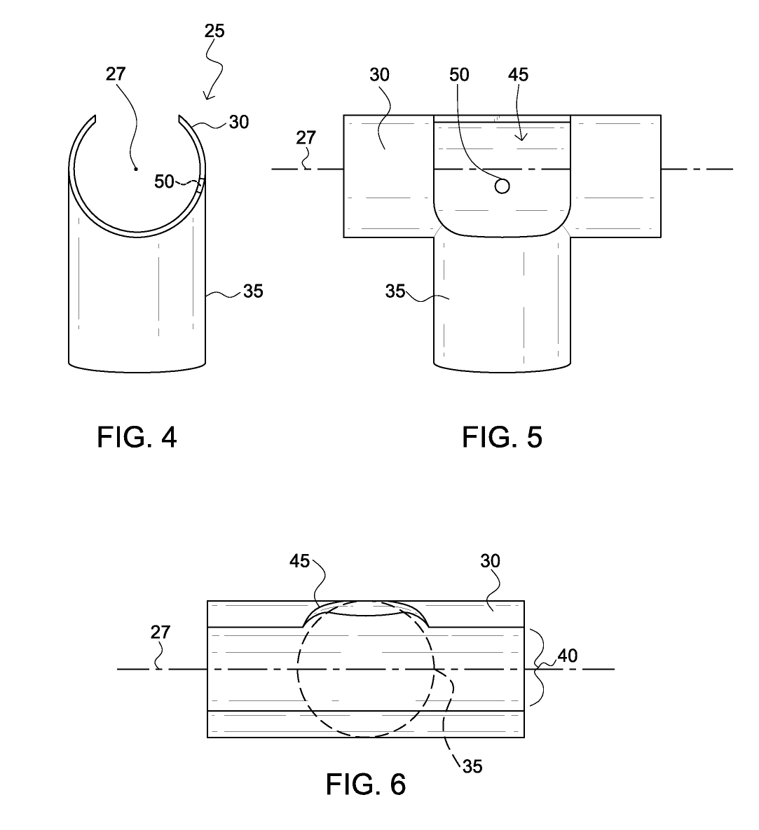

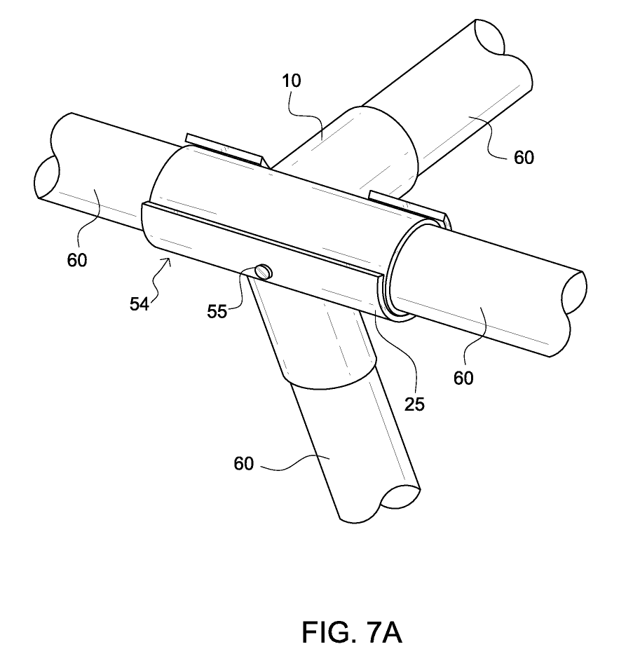

FIGS. 2 & 4-6 illustrated a modified pipe tee 25 from several views. The modified pipe tee is typically used in combination with an appropriately-sized corresponding standard pipe tee 10 as is shown in FIG. 3. Other uses of the modified pipe tee are contemplated. The modified pipe tee comprises: (i) a longitudinally-extending base portion 30 (also referred to as a “body portion” herein) that is modified relative to the base portion 15 (see FIG. 1) of a standard pipe tee; and (ii) an annular appendage 35 that extends radially outwardly from the base portion typically at a 90 degree angle relative to a longitudinal axis of the base portion. In at least some variations the annular appendage is centered about a longitudinal center location of the base portion. The annular appendage is typically similar to an annular appendage 20 of a standard pipe tee.

In at least one variation, the modified pipe tee 25 comprises a polymeric material, such as Polyvinyl chloride (PVC). When the modified tee is substantially comprised of PVC, for instance, and offered in standard sizes, it is compatible with PVC pipe both in fitment and the ability to fuse the fitting to a pipe received in the annular appendage 35 if coated with standard PVC pipe cement, which acts to fuse two pieces of PVC together. Pipes made of Acrylonitrile Butadiene Styrene (ABS) are also well known and readily available, accordingly variations of the modified pipe tee are contemplated that are made of ABS to effectively join with ABS pipe using ABS pipe cement. Additionally, variations of the modified pipe tee can be made from other suitable plastic materials and even metallic materials.

The most significant differences between a standard pipe tee 10 and the modified pipe tee 25 is the configuration of the respective tees' base portions 30 & 15 (or body portions). Specifically, unlike the standard pipe tee, the body portion 30 of the modified tee is not fully annular. In other words, the body portion of the modified pipe tee does not comprise a fully cylindrical sidewall. Rather, the body portion is generally cylindrical in shape having a sidewall that is evenly spaced from a central longitudinal axis 27 but it is further defined by two interconnected cutout sections 40 & 45.

The first cutout 40 extends longitudinally along the sidewall of the body portion 30 and has a circumferential width of less than 3.14 radians (180 degrees) and more preferably less than 2.1 radians (about 120 degrees). The first cutout is flanked on its two longitudinal sides by respective spaced apart first and second longitudinal edges 42 & 44 of the sidewall. In variations, the first cutout is located on the body portion at a location generally opposite the annular appendage 35, such that the annular appendage and the first cutout face outwardly in opposite directions.

The body portion 35 is generally rigid typically being comprised of a rigid material but given the relative thinness of the body portion's sidewall and the properties of the materials of which it is comprised, the body portion is elastically resilient permitting temporary small changes in the linear width of the first cutout when and while a sufficient external load is applied. This resiliency allows a user to spread the linear width an amount greater than the outside diameter of a corresponding standard pipe tee 10 so that the modified tee 25 with a body portion inside diameter similar to the outside diameter of the standard tee can be received over the standard tee. When the user removes the spreading load, the linear width of the modified tee spring backs to a dimension less than that of the standard tee's outside diameter thereby securing the modified tee over the standard pipe tee as shown in FIG. 3.

To facilitate receiving the standard pipe 10 with its annular appendage 20 over the modified pipe tee 25 and to facilitate rotation of the pipe tees relative to each other about their coincident longitudinal axes 12 & 27 to change the angle between the respective annular appendages 20 & 35, a second cutout 45 is provided on the modified tee. The second cutout is generally located in the middle of the base portion 30 at a similar longitudinal position as the annular appendage 35. The second cutout bisects the first edge 42 of the sidewall that borders one side of the first cutout and extends circumferentially therefrom. Typically, but not necessarily, the second cutout has a width substantially parallel to the longitudinal axis 27 that is equal or greater than the appendage's outside diameter.

In some variations of the modified pipe tee 25, a small threaded bore 50 is provided through the body portion 30 as shown in FIG. 2. The bore receives a set screw 55 therein for tightening against the surface of the base portion 15 of standard pipe tee 10 that is received in the modified tee. This permits a use to secure the respective pipe tees once the desired angle between the respective annular appendages 20 & 35 has been determined It is to be appreciated that not all variations include the bore and corresponding set screw. In some circumstances pertaining to the use of the combination fitting 54 (See FIG. 3), the user may not desire to secure the fitting at a particular angle. In yet other circumstances, the user may want to more permanently set the angle between the appendages using an appropriate adhesive or cement, such as with PVC or ABS fittings.

### A Combination of a Modified Pipe Tee and a Standard Pipe Tee According to One Embodiment of the Present Invention

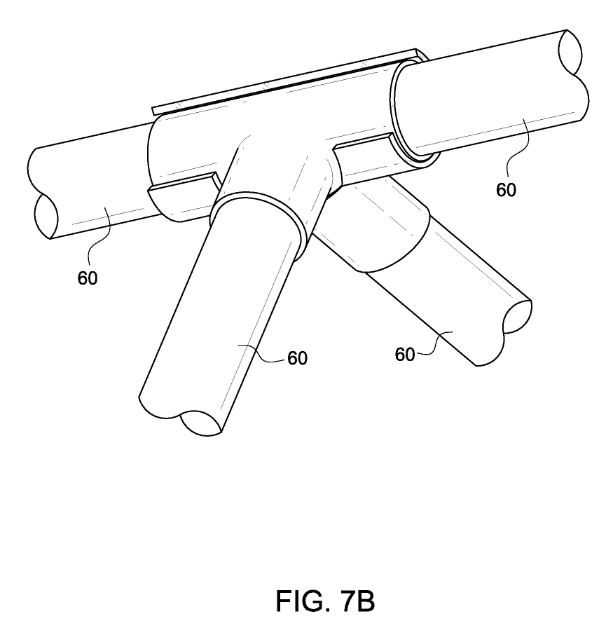

Referring to FIG. 3, a combination fitting 54 comprised of a modified pipe tee 25 and standard pipe tee 10 is illustrated. Further, FIGS. 7a & b illustrate the pipe tee combination fitting in further combination with tubing 60 to create a pipe structure.

A standard pipe tee 10 is illustrated alone in FIG. 1. Standard pipes tees are well known in the art and are a common fitting used in plumbing as well as the construction of plastic pipe structures. As is indicated above, the typical standard pipe tee comprises an annular base portion 15 having a longitudinal center axis 12 that unlike the modified pipe tee 25 comprises a cylindrical sidewall with exterior and interior surfaces not interrupted by cutouts. Similar to the modified tee, an annular appendage 20 extends outwardly from a generally longitudinal center location of the base portion. Of significance, most standard pipe tees are configured to receive the end of a standard size pipe or tubing in each of its three open ends (two ends on either side of the base portion and one open end at the terminus of the annular appendage). Where the pipe is plastic, adhesive or cement can be used to secure the pipe within an open end. In other circumstances, the frictional or interference fit of the pipe within the fitting end is sufficient to hold it in place. Typically, but not necessarily, all three open ends have similar inside diameters as they are each configured to receive the same size pipe.

Referring back to FIG. 3, the standard pipe tee 10 is received in the modified pipe tee 25. Typically, the standard pipe tee can be fit into the modified tee by longitudinally aligning the annular appendage 20 of the standard tee with the second cutout 45 of the modified tee, placing the body portion 15 of the standard tee over the first cutout 40 and applying downwardly directed pressure causing the linear width of the first cutout to splay until the standard tee is received therein. As the standard tee is fully received within the modified tee wherein the longitudinal axes 12 & 27 of the respective body portions are substantially coincident, the edges 42 & 44 bounding the first cutout snap back restoring the first cutouts' width to (or near) its unrestrained dimension. Since the outside diameter of the standard tee is typically similar the inside diameter of the modified tee, the standard tee is held tightly within the modified tee with limited lateral movement. Further, the second cutout in which the annular appendage of the standard pipe tee is received prevents significant longitudinal movement of the respective tees. Of significant note the longitudinal locations of the annular appendages of both the tees are similar; i.e. the axes of the annular appendages are coplanar and generally orthogonal to the longitudinal axes of the respective body portions.

In at least one variation of the combination fitting 54, the modified pipe tee is constructed by modifying a standard pipe tee one standard size larger than the standard pipe tee 10 that is to be received in the modified tee. For instance, if the standard pipe tee 10 is a 1.25″ tee than a 1.5″ standard tee is used to fabricate the modified pipe tee 25. The modification comprises the removal of material from the body portion of the tee to create the first and second cutouts 40 & 45.

Of note, no matter the construction of the combination fitting 54, the standard tee 10 is able to rotate about it longitudinal axis 12 relative to the modified tee 30 unless otherwise purposefully and intentionally constrained. Accordingly, the angle between of the axes of the respective annular appendages 20 & 35 can vary from about 90 degrees to about 170 degrees.

In at least one variation a threaded bore 50 is provided through the body portion 30 of the modified pipe tee 25 and an appropriately sized set screw 55 is received therein. Accordingly, in use the set screw can be tightened against the outside surface of the standard pipe tee's base portion 15 to hinder if not prevent the free rotational movement of the respective appendages 20 & 35 relative to each other. Typically, the set screw will be tightened after the necessary angle of the respective annular appendages is determined for the construction of a desired structure. In some instances, a user may tighten the set screw before construction of the associated structure once he/she has determined the desired angle, or in other instances, the user may allow the relative angle to float for a particular fitting until the structure is assembled and then tighten the set screw.

In another variation, a set screw is not received in a bore on the modified pipe tee 25 but in a bore provided through the standard pipe tee 10. In this variation, the set screw extends radial outwardly from the inside surface of the body portion 15 through the associated bore and impinges on the inside surface of the modified tee's body portion 30 to secure the two tees in place relative to each other. Access to the set screw in the interior of the standard tee's body portion is provided through the interior of tee's annular appendage. Accordingly, the desired angle between the appendages of the combination fitting is usually set prior to the attachment of pipes to the fitting. Considering the foregoing paragraphs, it is to be appreciated that the location of a set screw can vary both between the two tees as well as the particular location of the set screw on a respective body portion of one of the tees.

As an alternative to the set screw 55, the two tees 10 & 25 can be secured in place relative to each other using a suitable adhesive or cement. For instance, once the desired angle is known, the user can apply cement to either or both the exterior surface of the standard tee and the interior surface of the modified tee prior to connecting the two tees together. The user would than interconnect the tees in the manner described above and quickly adjust the tees for a desired annular appendage angle before the tees fuse. Another manner of bonding the two tees is to (i) rotate the standard tee to expose some of its exterior surface that will be located under the side wall of modified tee when the appendage angle is set, (ii) place some cement on this surface portion, and (iii) rotate the standard tee to the correct angle relative to the modified tee and permit the cement to set.

In yet another variation, one or more tie wraps or band clamps can be used to secure the modified tee in place relative to the standard tee. Effectively, the tie wrap when tightened around the outside of the modified tee's body portion creates a compressive force that substantially increases the friction between the outside surface of the standard tee and the inside surface of the modified tee locking the tees in their relative positions.

The combination fitting 54 is typically combined with pipe 60 or tubing to create three dimensional structures. FIGS. 7A & 7B illustrate from different angles a portion of a structure including a single fitting and four pipes attached thereto and extending therefrom. Most Typically, the combination fitting is utilized to connect four lengths of tubing 60 together; however, in some variations of the fitting a single continuous piece of tubing can be slid through the body portion. As shown in both Figures, one section of tubing 60 is received in the annular appendage 35 of the modified pipe section; a second section of tubing 60 is received in the annular appendage 20 of the standard pipe section; a third section of tubing 60 is received in one end of the base portion 15 of the standard pipe fitting; and a fourth section of tubing 60 is received in the other end of the base portion of the standard pipe fitting. The outside diameters of the tubes are generally similar to the inside diameters of the fittings ensuring a relatively tight friction fit; however, the tubes can be bonded within the fittings as desired. For instance, where the tubes and associated fittings comprise PVC or ABS, a suitable cement is utilized to soften the thermoplastic material and cause the tubes to fuse within the fitting as the solvents in the cement evaporate and the plastic re-hardens.

A typical use of the combination fitting 54 is to create roof structures wherein the pitch of the roof is that is which is not readily achievable using off the shelf prior art four-way fittings with predetermined angles between appendages. For instance, as Shown in FIGS. 7A & B, the one or more tubes extending into or through the base portion 15 of the standard tee 10 of the combination fitting typically form a ridge beam of the roof structure; whereas, the tubes extending from the annular appendages 20 & 35 form rafters.

Another use of the combination fitting 54 is to couple a rafter to the associated wall structure on which the roof rests. In this application, the pipe(s) 60 secured to the body portion 15 of the standard pipe tee comprise the top horizontally extending plate of the underlying wall. One annular appendage is coupled to the rafter beam/pipe and the other annular appendage is coupled to a stud pipe of the wall. Accordingly, when the combination fitting is utilized loading in the rafter pipes are transferred substantially directly to associated stud pipes and subsequently to the ground surface on which the wall rests, thereby minimizing the transfer of load horizontally across a top plate and improving structural efficiency.

### A Method of Making a Modified Pipe Tee According to Embodiments of the Present Invention

Embodiments of the modified pipe tee 25 can be made by a number of different methods. Two of these methods are described herein although others have been contemplated. One method involves modifying a standard pipe tee 10 while the other method involves molding the modified tee 25 in its final form.

To modify a standard pipe tee 10 of the type described herein, a first section of the annular base portion 15 is removed mechanically typically by sawing or cutting to create the first cutout 40. The first cutout has a circumferential width of less than 3.14 radians or a linear width of less than the outside diameter of the base portion 30. The first cutout is typically located on the base portion generally opposite the annular appendage 35 and is bounded by first and second longitudinal edges created with the first cutout 42 & 44.

Next, a second section of the first annular base portion 15 of the formally standard pipe tee is removed also typically by sawing or cutting to create a circumferentially-extending second cutout 45 that extends from the first longitudinal edge 42 to a location proximate the intersection of the base portion with the annular appendage 35. The second cutout typically has a width that is substantially parallel to the longitudinal axis 27 and is equal or greater than the appendage's outside diameter.

In some variations, a threaded bore 50 may be formed into the remaining base portion that extends generally radially from the base portion's exterior surface to the base portion's interior surface. A set screw 55 is then typically threaded into the threaded bore.

The other method of fabricating the modified pipe tee 25 involves molding, such as injection molding, the tee in its final configuration or near final configuration. Using this method molten thermoplastic, such as ABS or PVC, is injected under pressure into a mold that defines a cavity in the shape of the modified tee. The molten plastic displaces the cavity void and cools against the typically metallic surface of the mold to re-solidify. The mold, which typically comprises a plurality of pieces, is opened and the substantially finished part is removed. It is sometimes necessary for residual flashing to be removed from the finished part. Further, in some variations the threaded bore 50 may be formed in the part during a post-molding operation.

### A Method of Creating a Structure Using One or More Combination Fittings According to an Embodiment of the Present Invention

A typical pipe structure that uses at least one combination fitting 54 will utilize a plurality thereof. For example when the fittings are used to construct a gabled roof, one combination fitting is used for joining a rafter pair to the roof's ridge and two more fittings for the joining the rafter pipes to the respective walls and a roof will usually require many rafters. The method briefly described herein pertains to the joining of tubes or pipes to a single fitting. It is to be appreciated that the described method will likely be repeated a plurality of times in constructing an entire structure.

Typically, four tubes (or pipes) are coupled to a single combination fitting, although as indicated above in certain circumstances a single tube can be slid through the base portion 15 of the standard fitting instead of having two separate tubes 60 being coupled to opposite ends of the base portion. A tube is typically coupled to the annular base portion 20 of the standard pipe tee 10, which has been received in the modified pipe tee 25 to for the combination. An end of a pipe, which has an outside diameter similar to the inside diameter of the standard pipe tee is slid into one of the ends of the base portion. Where the creation of a permanent structure is desired and the pipe and fitting comprise a suitable polymeric material, such as PVC or ABS, the respective mating surfaces can be coated with a suitable cement to cause the pipe to fuse with the fitting. However, where future disassembly is contemplated or even desired, the frictional fit between the pipe and fitting ends is usually sufficient to hold the pieces together. Another tube can be similarly coupled to the other end of the standard tee's annular base portion.

Two additional tubes 60 are also coupled to the respective annular appendages 20 & 35 of the fitting: the one annular appendage 35 extending from the modified tee 25 and the other annular appendage 20 extending from the standard tee 10. The tubes 60 are fit within the respective annular appendages in a similar manner as described for the base portion.

At some point during the process, the angle of the longitudinal axes of the respective annular appendages 20 & 35 relative to each other is adjusted by rotating the modified pipe tee 25 relative to the standard pipe tee 10 about their coincident base portion longitudinal axes 12 & 27. Once the desired angle is set, the user can tighten the set screw 55 (if the fitting is so equipped) to secure the position of the respective pipe tee's relative to each other. It is appreciated that when the angle is set during the fabrication process can vary depending on the use of the combination tee and the assembly methodology employed by a particular user. For instance, in some circumstances, the angle may be set before assembly of the fitting with the tubes especially where the user knows precisely what the desired angle is for the particular structure being constructed. In other instances, the relative angle may be permitted to float during assembly and only fixed after the associated pipes are fully secured in the subject fitting as well as any other associated fittings. The later methodology permits a user to assemble a structure quickly and easily without ever having to calculate a particular angle.

### Other Variations and Embodiments

The various preferred embodiments and variations thereof illustrated in the accompanying figures and/or described above are merely exemplary and are not meant to limit the scope of the invention. It is to be appreciated that numerous variations to the invention have been contemplated as would be obvious to one of ordinary skill in the art with the benefit of this disclosure. For instance, the combination fitting described herein is a 4-way fitting; however, the creation of three way combination fittings that combine elbows instead of tee is contemplated. Further in another variation, a 4-way fitting is substituted for the 3-way standard tee and the modified tee is further modified with a third cutout that extends circumferentially in an opposite direction from the first cutout as the second cutout to accommodate the second annular appendage of the 4-way fitting. The result is a 5-way combination fitting with three annular appendages.

1. A modified pipe tee comprising:
A longitudinally-extending base portion, the base portion having an arcuate interior surface that extends circumferentially around a longitudinal center axis and an exterior surface; and
an annular appendage, the annular appendage having an appendage interior surface, an appendage exterior surface, and an appendage inside diameter and an appendage outside diameter, the annular appendage extending radially outwardly from the base portion exterior surface;
wherein the base portion further defined by (i) a longitudinally-extending first cutout having a circumferential width of less than 3.14 radians and spaced apart first and second longitudinal edges, the first cutout being located generally opposite the annular appendage, and (ii) a circumferentially-extending second cutout extending from the first longitudinal edge to a location proximate the intersection of the base portion with the annular appendage, the second cutout having a width substantially parallel to the longitudinal axis and equal or greater than the appendage outside diameter.

2. The modified pipe tee of claim 1, wherein the annular appendage is located on the base portion substantially proximate the longitudinal center thereof.

3. The modified pipe tee of claim 1, further including a threaded bore extending generally radially from the base portion exterior surface to the base portion interior surface.

4. The modified pipe tee of claim 3, further comprising a set screw, the set screw being threadably received in the threaded bore.

5. The modified pipe tee of claim 1 wherein the modified tee is substantially comprised of a rigid polymeric material.

6. The modified pipe tee of claim 5 wherein the rigid polymeric material comprises Polyvinylchloride (PVC).

7. In combination, the modified pipe tee of claim 1 and a standard pipe tee, the combination comprising:
the standard pipe tee, the standard pipe tee including (a) an annular base portion having a longitudinal center axis, an inside and an outside diameter with corresponding exterior and interior surfaces and, an annular appendage extending radially from the base portion and including inside and outside diameter also including corresponding interior and exterior surfaces;
wherein (1) the annular base portion of the standard pipe tee is received at least partially within the base portion of the modified pipe tee with the longitudinal axis of both the modified pipe tee and the standard pipe tee are substantially coincident with each other, and (2) the annular appendage of the standard pipe tee at least partially passes through the second cutout of the modified pipe tee.

8. The combination of claim 7 wherein the combination further includes: a threaded bore extending generally radially through one of (i) the annular base portion of the standard pipe tee and (ii) the base portion of the modified pipe tee, the set screw being received in the threaded bore.

9. The combination of claim 7, wherein both the standard pipe tee and the modified pipe tee comprise PVC or ABS.

10. The combination of claim 7 wherein the inside diameter of the base portion of the standard pipe tee is substantially similar to the inside diameter of the annular portion of the standard pipe tee and the inside diameter of the annular portion of the modified pipe tee.

11. The combination of claim 10, further comprising at least three lengths of annular tubing, each tube having a outside diameter of substantially similar to the inside diameter of the base portion of the standard pipe tee with a first tube of the at least three lengths of annular tubing being received in the annular appendage of the modified pipe tee, a second tube of the at least three lengths of annular tubing being received in the annular appendage of the standard pipe tee, and a third tube of the at least three lengths of annular tubing being received in the base portion of the standard pipe tee.

12. The combination of claim 11, wherein the tubes, the standard pipe tee and the modified pipe tee all comprise PVC and each tube is bonded one of the annular appendages of the standard and modified pipe tees and the base portion of the standard pipe tee.

13. The combination of claim 11, further comprising a fourth tube of the at least three lengths of annular tubing, the fourth tube being received in the base portion of the standard pipe tee along with the third tube.

14. The combination of claim 11 wherein the first tube has first longitudinal axis, the second tube has a second longitudinal axis and the axis intersect at an angle of 90-170 degrees.

15. A method of creating a structure using tubing and the combination of claim 7, the method comprising:
providing the combination of claim 7;
providing three or more tubes each tube having a longitudinal axis;
securing a first tube of the three or more tubes to the annular base portion of the standard pipe tee by sliding an end of the first tube into one end of the base portion;
securing a second tube of the three or more tubes to the annular appendage of the standard pipe tee by sliding an end of the second tube into an open end of the annular appendage;
securing a third tube of the three or more tubes to the annular appendage of the modified pipe tee by sliding an end of the third tube into an open end of the annular appendage; and
adjusting the angle between the longitudinal axes of the second and third tubes by rotating the modified pipe tee relative to the standard pipe tee about the coincident longitudinal axes of both pipe tees.

16. The method of claim 15 wherein the combination further includes a threaded bore extending generally radially from one of (i) the base portion exterior surface to the base portion interior surface and (ii) the annular base portion exterior surface to the annular base portion interior surface, and a set screw threadably received in the thread bore, the method further comprising tightening the set screw to set the angular position of the annular appendages of the respective standard and modified pipe tees.

17. The method of claim 15, wherein said steps of securing of the first, second and third tubes further includes bonding the tubes to the respective pipe tees.

18. The method of claim 15, further comprising securing a fourth tube of the three or more tubes to the annular base portion of the standard pipe tee by sliding an end of the fourth tube into another end of the base portion.

19. A method of making a modified pipe tee, the method comprising:
providing a standard pip tee, the standard pipe tee including (a) an annular base portion having a longitudinal center axis, an inside and an outside diameter with corresponding exterior and interior surfaces and, an annular appendage extending radially from the base portion and including inside and outside diameter also including corresponding interior and exterior surfaces;
removing a section of the annular base portion to create a longitudinally-extending first cutout having a circumferential width of less than 3.14 radians and spaced apart first and second longitudinal edges, the first cutout being located generally opposite the annular appendage; and
removing another section of the annular base portion to create a circumferentially-extending second cutout extending from the first longitudinal edge to a location proximate the intersection of the base portion with the annular appendage, the second cutout having a width substantially parallel to the longitudinal axis and equal or greater than the appendage outside diameter.

20. The method of claim 17, further comprising forming a threaded bore that extends generally radially from the base portion exterior surface to the base portion interior surface.
